(19) United States
(12) Patent Application Publication
(10) Pub. No.: US 2006/0222223 A1
(43) Pub. Date: Oct. 5, 2006

(54) Methods and systems for analyzing bone conditions using mammography device

(76) Inventors: Xiaoli Bi, Cerritos, CA (US); Phillip M. Berman, Coronado, CA (US); Louai Al-Dayeh, Torrance, CA (US); John McLaughlin, Palos Verdes, CA (US)

Correspondence Address: PERKINS COIE LLP, POST OFFICE BOX 1208, SEATTLE, WA, 98111-1208, US

(21) Appl. No.: 11/282,303

(22) Filed: Nov. 18, 2005

Related U.S. Application Data
(60) Provisional application No. 60/629,477, filed on Nov. 18, 2004.

(51) Int. Cl. G06K 9/00

(52) U.S. Cl. 382/128

(57) ABSTRACT

Methods and systems for analyzing bone tissue using a mammography device is provided. Image data is obtained from the mammography device and used to generate a bone condition profile. The bone condition profile includes use of radiographic absorptiometry methods to construct a representative mammography profile of a particular sample tissue. The bone condition profile includes a measure of bone mineral density.

### CROSS-REFERENCE TO RELATED APPLICATIONS

This application claims priority to U.S. Provisional Application Ser. No. 60/629,477 filed on Nov. 18, 2004, which is incorporated herein by reference in its entirety, including all drawings, figures and examples.

### BACKGROUND

A mammography device is a radiographic system that uses x-ray technology to detect abnormalities within soft tissue of a breast. Women over forty years of age are recommended to get a mammogram every year. The same group of people have tendency to develop bone-related diseases or conditions such as osteoporosis and arthritis and therefore need to be screened or diagnosed in routine physical examination as well. Currently, these bone conditions are detected using a bone densitometry or other bone disease related devices that utilize specially designed or regular x-ray technology, which are different from conventional mammographic devices and are often at different locations. In addition, separated appointments are needed for a patient to get both a mammogram and a bone disease screening done.

It is therefore desired to examine women with the same radiography device in a single physical examination location or facility to diagnose the conditions for the breast as well as the bone. However, using an existing mammogram device to cast a bone image and perform a bone condition analysis has been a challenge, because the mammogram device uses lower peak kilo voltages and higher mass detection to achieve optimum contrast for detecting abnormality from breast soft tissue; while a bone densitometry or other bone related devices uses higher peak kilo voltages and lower mass to achieve high X-ray penetration to the bone. The peak kilo voltages used for the mammogram equipment were considered as not enough to penetrate a bone.

In recent years, the advent of computer aided diagnosis, digital mammography and its advanced detectors has provided clinicians with systems that not only deliver wide range of peak kilo voltages, but also make efficient use of the x-ray intensities. It therefore becomes possible to use a mammography device to obtain an image of a bone and analyze bone conditions thereof with computer-aided diagnosis (CAD) software.

### SUMMARY

One embodiment of the present disclosure relates to a method of using a mammography device in the analysis of bone conditions. In particular, the method comprises the step of placing a body part containing a bone in a mammography device, passing X-ray through the part to generate signals on a mammography detector, and analyzing the signals to predict a bone condition for the bone. The method further comprises a step of converting the signals about the bone in the detector into a computer digital file.

Another embodiment of the present disclosure relates to a system of using a mammography device in the analysis of bone conditions. In particular, the system comprises 1) a mammography device; 2) a mammography detector or a panel, wherein the detector or the panel receives and records signals from mammography device-generated X-rays passing through a bone; and 3) a computer-aid diagnosis system that analyzes a bone condition for the bone from the signals.

Another embodiment of the present disclosure relates to a computer-aided diagnosis system, medium or software that is designed to diagnose bone conditions from signals or information about a bone recorded on a mammography detector or a panel.

### BRIEF DESCRIPTION OF THE DRAWINGS

FIG. 1 is a flow chart depicting some of the steps to generate an image for a breast as well an image for bones in accordance with the present disclosure;

FIG. 2 depicts a sample image obtained using a digital mammography device;

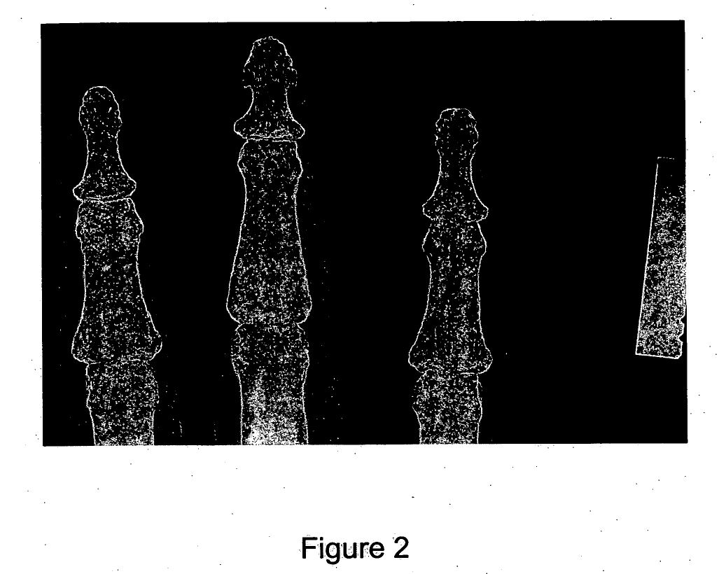

FIG. 3 depicts a sample image obtained using a digital mammography device and analysis in accordance with the present disclosure; and

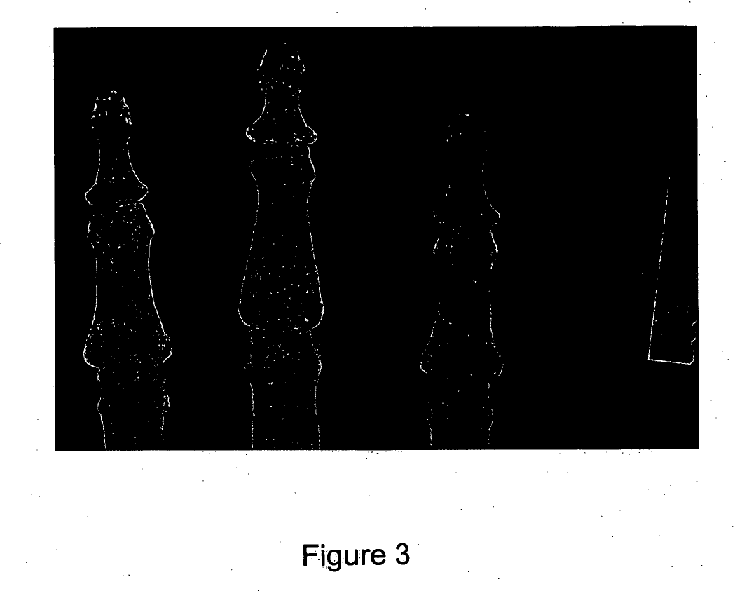

FIG. 4 depicts a sample wedge longitudinal profile comparison.

### DETAILED DESCRIPTION

Hardware improvements in mammography devices and computer aided diagnosis system unexpectedly allow the analysis of bone conditions using the devices that have traditionally been used to analyze breast tissue only.

For example, new mammography devices, e.g., digital mammography devices, provide higher energy spectra and wider range of peak kilo voltages (kVp) than conventional mammography machines. Conventional mammography machines usually use a consistent energy level of 25 kVp which is good for soft tissues but not for bone structures. A digital mammography device may peak at near 40 kVp for dense breasts with the aid of computer image enhancement to achieve optimum results. Therefore, the X-rays generated from the new devices can not only examine soft tissues such as breasts to provide a high resolution image for breasts but also penetrate a bone structure (e.g., bone extremities such as fingers or toes) to provide an image for the bone. Furthermore, although conventional mammography devices are theoretically able to achieve energy levels sufficient to penetrate bone tissue, such devices do not generally remain at peak levels long enough to allow adequate imaging of the bone tissue for a determination of a clinical condition.

In addition, a digital mammography device provides a larger image view area (e.g. full field) than conventional mammogram machines (24×30 cm) and makes it suitable for almost all of the bone extremities. A digital mammogram can provide high resolution to detect degeneration or bone loss in representative areas of a patient such as a small bone joint in a hand or finger. Since the pixel size of the detector is as small as 50 microns, a smaller area of an individual's body part can be used for image sampling to determine the particular condition of the individual's bone quality, bone density or bone mass. Additionally a particular bone condition or fracture risk can be predicted.

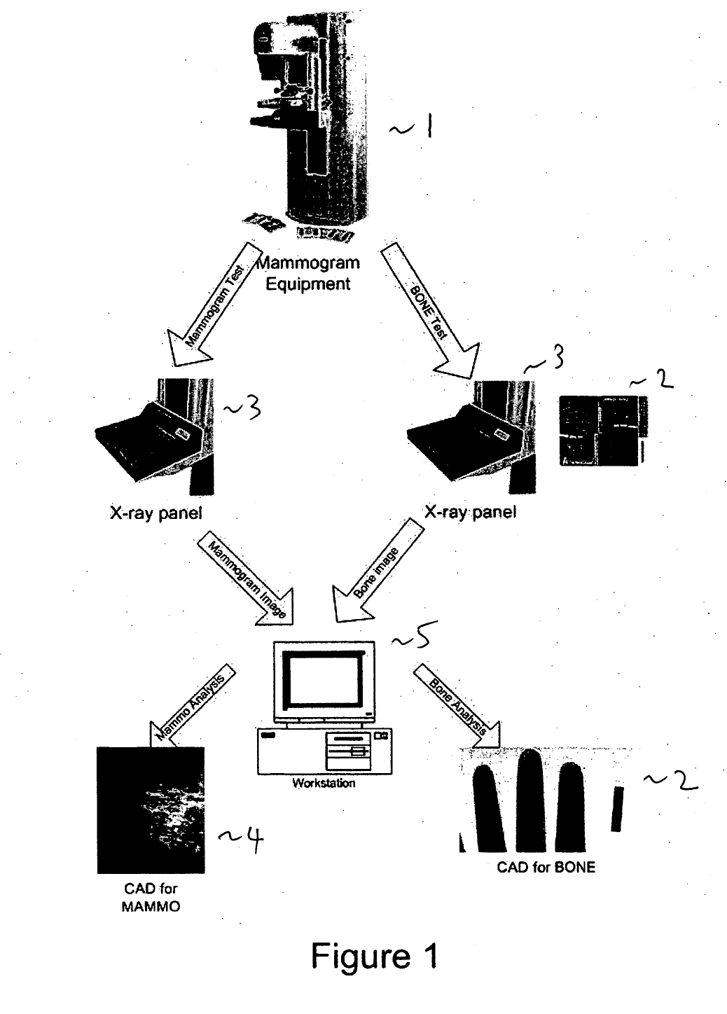

FIG. 1 depicts exemplary components and steps involved in using a mammography device 1 and a CAD processing unit according to the present disclosure for determining or monitoring an individual's bone condition. The system includes a mammogram imaging device (MID) 1 and a CAD processing unit 5. The MID1 and CAD processing unit 5 may be housed in the same structure or workstation or may be located at different sites such as in separate workstations, rooms or buildings depending on the particular implementation or design of the system.

Also shown in FIG. 1 is a conceptual diagram of the steps involved in revealing information regarding an individual's bone condition using the same device as used to obtain the patient's breast tissue condition. For example, in a scenario in which a patient has an X-ray mammogram image taken for purposes of a standard mammography exam, the same X-ray panel 3 that is used to obtain an image of breast tissue 4 may also be used to obtain a bone image 2 from the same patient.

A conventional detection system uses a film-based detector or panel where X-rays passing through a tissue are collected by phosphor screens which then absorb the X-rays and create lights photons that spread and illuminate the film. However, film has a non-linear sensitivity to photon flux and less quantum efficiency at high optical densities and visibility of microcalcifications due to film granularity.

Although screen film can be used in new mammography equipment, digital detector technology provides additional advantages over screen-film mammography. See, e.g., Smith, Fundamentals of digital mammography: physics technology and Practical considerations, Radiology Management, vol. 25 (September/October 2003), the contents of which are incorporated herein by reference. For example, direct-conversion digital detectors use amorphous selenium to directly convert x-rays to electronic signals without first converting them to light and therefore achieve almost complete quantum efficiency. As a result, a digital mammogram device with digital detection technology provides a high quality image at a much lower radiation dose as compared to a conventional x-ray machine.

Accordingly, one aspect of the present disclosure relates to a system of using a mammography device to acquire an image of a bone and analyze bone conditions. In particular, the system may include 1) a mammography device; 2) a mammography detector or panel, wherein the detector receives and records signals when mammography device-generated X-rays pass through a bone; and 3) a computer software that reconstructs the image data for analysis and review of a bone condition. In one embodiment, a digital mammography device 1 generates X-rays. The X-rays pass through finger bones 2, and transmit the finger image or information (signals) to digital X-ray panel 3 (See FIG. 1). The same device can be used to obtain a mammogram image 4 through the digital X-ray panel 3. The images are displayed on the mammogram workstation 5 and analyzed by a bone analysis software.

One aspect of the disclosure relates to a method of using a mammography device in the analysis of bone conditions. In particular, the method may include the steps of placing a body part contain a bone in a mammography device, passing X-ray from the device through the part on a mammography detector, recording information or image data about the bone in the detector, and analyzing the information or image data using a computer-aided system to predict or diagnose a bone condition or disease such as osteoporosis, arthritis, acromeglia, or other disorder associated with an abnormal level of bone density or bone mass.

In a preferred embodiment, a mammography device is a digital mammography device or a similar one that has the required specifications. A mammography detector includes, but is not limited to, a screen-film detector, a computed radiography detector, a direct radiography detector, a digital detector (e.g., an indirect-conversion digital detector or a direct-conversion digital detector). In another preferred embodiment, a mammography detector is a digital mammography detector or a panel. Particularly, a mammography detector is a direct-conversion digital detector.

In another preferred embodiment, a bone to be X-rayed or analyzed is an extremity bone such as a finger, a hand, a forearm, a toe, or a foot. Bone conditions include arthritis diseases (e.g., rheumatoid arthritis, osteoarthritis, infectious arthritis, and osteomyelitis), scoliosis, fracture, gout, bone cysts, bone degeneration diseases (e.g., osteoporosis), osteopetroses, osteoscleroses, craniotubular dysplasias, craniotubular hyperostoses, and sclerosteosis. In addition, bone conditions include bone age, bone volume, bone length, bone geometric changes, bone strength, bone cortical thickness, trabecular structure and bone mineral mass, as well as bone fracture risk prediction.

In another embodiment, the information or signals about a bone are received and recorded by a mammography detector. The information (or signals) can be displayed on a screen and analyzed by a computer-aided diagnosis medium or software that is designed to diagnose bone conditions from information (or signals) about a bone recorded on a mammography detector. Examples of the software include a software system for determining bone mineral density from radiographic images of a patient hand, using bone segmentation and contour analysis algorithms disclosed in U.S. Pat. No. 6,246,745 (the '745 patent) a software system capable of measuring the extent of rheumatoid arthritis, by segmentation and contour analysis of patient digit joints, is described in the U.S. patent application Ser. No. 10/625,444 (the '444 application), titled “Method, Code, and System for assaying Joint Deformity,” filed Jul. 22, 2003, which claims the benefit of U.S. Provisional Application Ser. No. 60/397,943, filed Jul. 22, 2002 (the '943 application); a software system capable of measuring the extent of rheumatoid arthritis, by segmentation and contour analysis of patient digit joints, described in co-owned U.S. patent application Ser. No. 10/625,444 (the '444 application), titled “Method, Code, and System for assaying Joint Deformity,” filed Jul. 22, 2003, which claims the benefit of U.S. Provisional Application Ser. No. 60/397,943, filed Jul. 22, 2002 (the '943 application); and a method for segmenting digits as part of the bone analyses procedures in U.S. Pat. No. 6,711,282, titled “Method for Automatically Segmenting a Target Bone” (the '282 patent). All above-mentioned patents and applications are incorporated herein in their entirety by reference thereto. The bone image can also be analyzed by any improved version of the above-mentioned software.

The bone information (signals) or image data in the mammography detector can be transferred or converted into a computer file, e.g., a Digital Image Communication in Medicine (DICOM) compliant file or image, and be analyzed by above-mentioned software or any improved version thereof. The computer file can also be archived or transmitted to a server system such as the Picture Archiving and Communication System (PACS) or a place different from the location of the mammography device and analyzed in accordance with the methods as disclosed in PCT application PCT/US04/019749, which claims the benefit of U.S. Provisional Application No. 60/480,306, filed Jun. 19, 2003, and U.S. Provisional Application No. 60/551,623, filed Mar. 8, 2004, both of which are incorporated herein in their entirety by reference thereto.

Another aspect of the present disclosure relates to an algorithm or software that can detect an optimum setting for the bone analysis based on a quick pre-exposure of a reference object. The reference object is used for automatic exposure control (AEC) for different bone tests.

In some instances the image data may be viewed as acquired, i.e., raw, or after processing. As one of ordinary skill in the art will appreciate, the various components of the imaging system may be routinely calibrated to maintain the desired physical and/or radiological characteristics. For example, properties that may be calibrated to provide consistent image data in terms of intensity, dosage, dynamic range and so forth. Calibration may be accomplished using a specified calibration protocol such as in conjunction with specific calibration phantoms or in the context of a patient or individual exam. Examples of calibration phantoms include material decomposition calibration phantoms or other geometric structures for geometry calibration. Calibrations performed in the context of an individual or patient exam may be performed based on markers or specified references extracted from the imaged body, anatomy or other property of the imaged object.

Another aspect of the present disclosure relates to image processing algorithms or software. A digital mammography image is normally preprocessed using a number of filters and contrast enhancement tools for display purposes. This process may affect the accuracy bone condition that is detected. Therefore, image processing algorithms are developed to automatically detect the preprocess operations and reverse engineer the bone image close to its original image or pre-processed status. The reverse-engineering process is particular useful in analyzing bone mineral density (BMD) because the calculation is based on optical density of each pixel and the data from a calibration tool. A particularly useful calibration tool is a reference wedge such as an aluminum alloy wedge as disclosed in U.S. Pat. No. 6,246,745 to Bi et al., which is hereby incorporated by reference in its entirety. In the process, a wedge data reference curve from a calibration tool or reference wedge is generated by taking an image of the calibration tool using a standard X-ray device. The same X-ray device and X-ray settings as used to capture the image of the calibration tool is used to image a phantom or test sample such as a sample body part. The resulting gray scale image includes a plurality of pixels each representing one unit area in the original image and having one gray shade value. For example, each pixel in the calibration tool is represented by a bit level (gray level). A standard or reference profile is then generated and mapped to the standard one pixel by one pixel using reverse algorithms. The bone data will be referred back to the mapped wedge data and calculated for BMD. For example, an arbitrary numerical value can be assigned to each thickness point reading of the phantom image relative to the equivalent thickness reading of the phantom image. The arbitrary numerical values or equivalent dataset for the phantom can then be used to generate a conventional X-ray profile. This wedge data can also be used to normalize a profile obtained from one or more mammographic images of a bone-containing sample of tissue to construct a reliable profile of the tissue's bone density. Using the profiles obtained from the mammographic images and the conventional X-ray images, a lookup table (LUT) can then be constructed to allow determination of BMD directly from a mammography device.

In one embodiment of the present disclosure, a lookup table (LUT) for use in determining a bone condition or for revealing a bone mineral density is created by mapping the optical densities (OD) in the images taken from a mammography device relative to the images taken from a standard X-ray device. For example, using the same calibration tool and phantom as used for creating a conventional X-ray profile as described above, a profile is obtained using a digital mammography device. The mammography profile will contain the image dataset that has been assigned to the phantom relative to the same calibration tool as used for the conventional X-ray dataset. The calibration tool-based value assigned to each phantom thickness point for the mammography profile is then mapped to the equivalent thickness point value of the conventional X-ray profile. Based on this relation, a lookup table (LUT) can be constructed allowing immediate correlation of an image captured using a digital mammography device to the standard (conventional X-ray) profile. This LUT can then be used to determine a bone condition or bone density value for a particular desired bone tissue sample.

In one embodiment of the present disclosure, analysis of an individual's bone condition can be performed using a form of radiographic absorptiometry (RA) methodology to measure the individual's BMD. In one exemplary RA technique, an aluminum wedge is used as a normative reference to calculate bone mass in aluminum thickness equivalency while also providing appropriate curve correction, thus allowing conversion of mammography image data into BMD information. C. Colbert, Radiographic absorptiometry (photodensitometry), in: S. H. Cohn (Ed.), Non-invasive measurement of Bone Mass and their Clinical Application, CRC Press, Boca Raton, Fla., 1981, pp 51-84; and U.S. Pat. No. 6,246,745 to Bi et al. A curve correction algorithm can be created by generating a lookup table (LUT) that includes a conventional profile from an image dataset or data structure obtained using a standard x-ray device. The LUT can then be constructed from a map of the mammography profile in relation to the conventional profile by: 1) obtaining a series of x-ray images of a phantom using a conventional radioimaging or x-ray device and a mammography device; 2) creating a longitudinal profile model for each image dataset using a reference aluminum alloy wedge; 3) constructing a look-up-table (LUT) based on the reference wedge thickness and the mammography profile as mapped against the conventional profile using polynomial curve fitting methodology; and 4) applying the LUT to obtain a new normalized image. Every pixel in the mammography image will be converted as:
Gn=F(Gm);
Where:
Gn—normalized gray level in the new image
Gm—the original gray levl in the mammography image
F(x)—is the curve correction transfer function

A conventional profile can also be derived by use of templates as described previously in U.S. Pat. No. 6,246,745 to Bi et al.

In a preferred embodiment, the mammography device has digital imaging capability or is a digital mammography device. A digital mammography device is generally designed to use lower voltages (20 to 30 kV) and higher current in order to allow sufficient focus on the soft tissue of breast. In contrast, a standard x-ray device uses higher voltages and lower radiation dosage in order to produce a sufficiently readable image of bone tissue. The present disclosure contemplates a method for converting images of bone tissue obtained using a digital mammography device into bone density or bone condition information. This information can be used to generate a bone condition profile or profile of an individual's physiological status of bone mineralization. Accordingly, the methods and systems of the present disclosure can be used to diagnose a disease or condition associated with a change in bone density or to establish a baseline or reference point from which future clinical bone condition determinations can be made.

Another aspect of the disclosure relates to a computer program module which transfers or converts information (signals) or images of bone in a mammography detector to a standard DICOM compliant archive or workstation.

Another aspect of the disclosure relates to a Graphic User Interface, which is designed to make the bone analysis work seamlessly with the digital mammogram device.

The systems and methods according to the present disclosure perform a bone condition analysis utilizing an existing digital mammogram system. When a patient comes to a women's healthcare facility for a routine mammogram test every year, a bone analysis can be performed on the same site with the same mammography device. For example, by imaging an extremity portion of a patient's body, such as a hand or forearm using the same mammogram device as used for the breast image, data regarding the patient's bone density can also be acquired. This measurement of bone density can then be used for early detection and screening of bone conditions. Where image data is acquired at different times such as from prior mammogram/osteogram visits, changes in the patient's bone condition over time may be determined and tracked. Accordingly, the systems and methods according to the present disclosure provide an easy and convenient way for an individual or person to be screened for both breast conditions and bone conditions (e.g., arthritis, osteoporosis, or other bone degeneration disease) at the same time in the same facility by the same device.

In another aspect of the disclosure, a system for the analysis of a bone condition is provided. Such a system can include a mammography device, a mammography detector, and a computer-aided diagnosis (CAD) system that analyzes a bone condition from the signals recorded in the detector. Additionally, the detector is designed so as to receive and records X-ray signals from the mammography device. For example, the mammography detector can be a screen-film detector, a computed radiography detector, a direct radiography detector, an indirect-conversion digital detector, a direct-conversion digital detector, and so forth. Additionally, the CAD system can include a workstation configured to reconstruct image data from the signals acquired by the detector, where the CAD system will contain software allowing analysis or determination of a bone condition or disease.

As will be evident to one skilled in the art, a computer software program of the present disclosure can be executed by being loaded into a system memory and/or a memory storage device through one of a variety of input devices. Alternatively, all or portions of the software program or code may also reside in a read-only memory, memory storage device or other tangible machine readable or executable media. It will be understood by one skilled in the relevant art that the software program or any portion of it may be loaded by a processor into a system memory, cache memory or both as needed for execution and use to analyze or determine a bone condition or BMD.

In another embodiment of the present invention, a computer software program product is provided for performing a bone condition analysis which. It is contemplated that the software program will be executable for mapping a real value obtained from a mammography reading to a standard value. For example, a software program that can be executed by a computer processor to perform the translation of a mammography image dataset in relation to a image dataset obtained using a standard x-ray device is included. Execution of the software program with values obtained from a sample tissue can then generate a bone condition profile for an individual. The software program's translation function can include the ability to assign a numerical value to each mammography image data point or value relative to a corresponding value obtained from a standard x-ray device reading. The datasets can be generated using an RA methodology and can include use of a calibration tool such as an aluminum alloy wedge. The aluminum alloy wedge can be a variety of thickness depending on the particular use. One preferred embodiment is a wedge thickness of about 0.5 to about 7 mm.

A computer system (e.g., a server system) according to the present invention refers to a computer or a computer readable medium designed and configured to perform some or all of the methods as described in the present invention. A computer (e.g., a server) used herein may be any of a variety of types of general-purpose computers such as a personal computer, network server, workstation, or other computer platform now or later developed. As commonly known in the art, a computer typically contains some or all the following parts, for example, a processor, an operating system, a computer memory, an input device, and an output device. A computer may further contain other parts such as a cache memory, a data backup unit, and many other devices. It will be understood by those skilled in the relevant art that there are many possible configurations of the parts of a computer.

A processor used herein may include one or more microprocessor(s), field programmable logic arrays(s), or one or more application specific integrated circuit(s). Illustrative processors include, but are not limited to, Intel Corp's Pentium series processors, Sun Microsystems' SPARC processors, Motorola Corp.'s PowerPC processors, MIPS Technologies Inc.'s MIPs processors, Xilinx Inc.'s Vertex series of field programmable logic arrays, and other processors.

An operating system used herein comprises machine code that, once executed by a processor, coordinates and executes functions of other parts in a computer and facilitates a processor to execute the functions of various computer programs that may be written in a variety of programming languages. In addition to managing data flow among other parts in a computer, an operating system also provides scheduling, input-output control, file and data management, memory management, and communication control and related services, all in accordance with known techniques. Exemplary operating systems include, for example, a Windows operating system from the Microsoft Corporation, a Unix or Linux-type operating system available from many vendors, another or a future operating system, and some combination thereof.

A computer memory used herein may be any of a variety of memory storage devices. Examples include any commonly available random access memory (RAM), magnetic medium such as a resident hard disk or tape, an optical medium such as a read and write compact disc, or other memory storage device. Memory storage device may be any of a variety of known or future devices, including a compact disk drive, a tape drive, a removable hard disk drive, or a diskette drive. Such types of memory storage device typically read from, and/or write to, a computer program storage medium such as, respectively, a compact disk, magnetic tape, removable hard disk, or floppy diskette. Any of these computer program storage media may be considered a computer program product. As will be appreciated, these computer program products typically store a computer software program and/or data. Computer software programs typically are stored in a system memory and/or a memory storage device.

As will be evident to those skilled in the relevant art, a computer software program of the present invention may be executed by being loaded into a system memory and/or a memory storage device through one of input devices. On the other hand, all or portions of the software program may also reside in a read-only memory or similar device of memory storage device, such devices not requiring that the software program first be loaded through input devices. It will be understood by those skilled in the relevant art that the software program or portions of it may be loaded by a processor in a known manner into a system memory or a cache memory or both, as advantageous for execution and used to perform a random sampling simulation.

In one embodiment of the invention, software is stored in a computer server that connects to an end user terminal, an input device or an output device through a data cable, a wireless connection, or a network system. As commonly known in the art, network systems comprise hardware and software to electronically communicate among computers or devices. Examples of network systems may include arrangement over any media including Internet, Ethernet 10/1000, IEEE 802.11x, IEEE 1394, xDSL, Bluetooth, LAN, WLAN, GSP, CDMA, 3G, PACS, or any other ANSI approved standard.

### EXAMPLE

Below is an exemplary application of one embodiment of the present invention. A study of screening osteoporosis using existing digital mammography (DM) equipment with radiographic absorptiometry: comparison of bone mineral density measurement between DM and regular film. The DM machine used was a full field digital mammogram (FFDM), the “Selenia” manufactured by LORAD (Hologic), USA. The DM settings used were 35 kVp and 5 mA. The standard x-ray equipment was a standard film-screen x-ray machine available at the University of California, San Diego Department of Radiology. The x-ray settings used for the OsteoGram was 0.001 uSv. The x-ray settings for this study were 50 kV, 100 mA, 1/60 sec.

The images acquired by the FFDM were standard DICOM images having a very high resolution (e.g. 360 dpi). The images were then copied onto media CDs and analyzed using a computer processor. The x-ray films acquired by the standard x-ray machine were developed and then processed according to the Osteogram method (CompuMed, Los Angeles, Calif.). They were digitized using a desktop flatbed scanner, Microtek 8700 at a resolution of 231 dpi. The BMD of the middle phalanges from images taken from the digital mammogram images and the standard x-ray images were then determined.

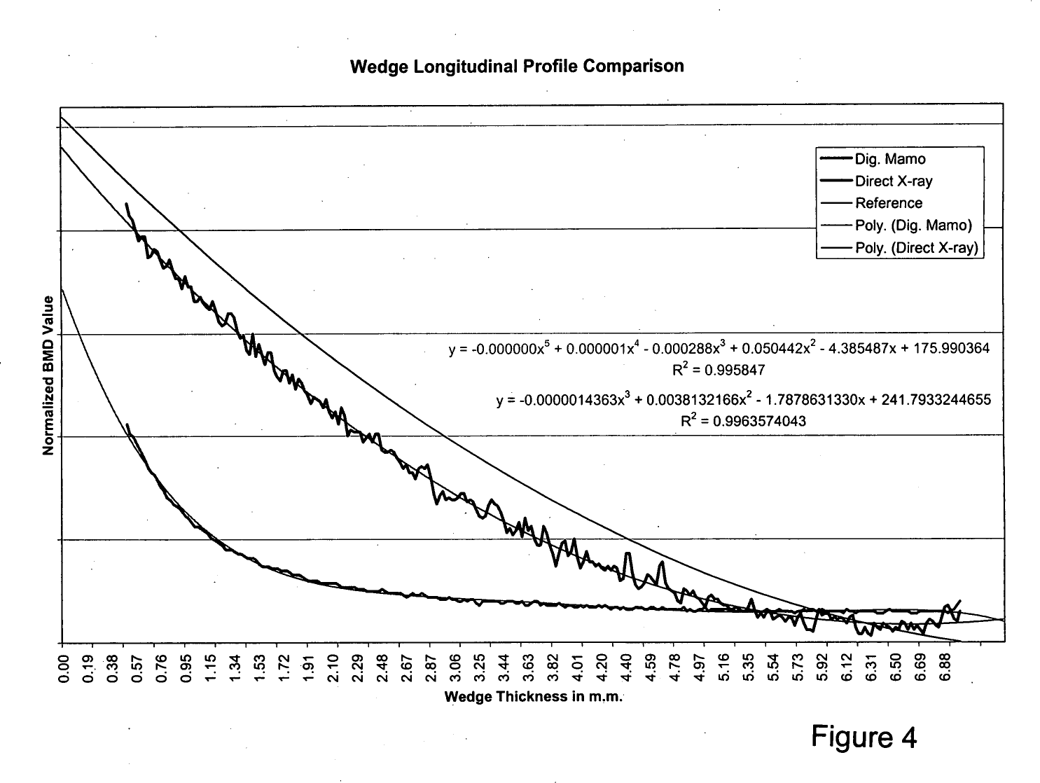

A clinical trial consisting of 50 female individuals between the ages of 40 to 78 was performed. Using both digital mammography equipment and a standard x-ray machine, views of each patient's phalanges are taken with an aluminum alloy reference wedge in each exposure. A series of aluminum wedge profiles were generated and used to construct a look-up-table (LUT). The LUT was applied as a curve correction transfer function to produce a normalized image from the mammography image. For each patient, the BMD results were then expressed in arbitrary units (AU). FIG. 4 are the results of the normalized BMD values plotted at each wedge thickness. Polynomial curve fittings and vectors were created based on the wedge thickness. For the digital mammography profile y=−0.000000x5+0.000001x4−0.000288x3+0.050442x2−4.385487x+175.990364 or y=−(0.0000000009*x⁵)+(0.0000008*x⁴)−(0.0003*x³)+(0.0504*x²)−(4.3855*x)+175.99R2=0.995847; and for the direct x-ray profile y=−0.0000014363x3+0.0038132166x2−1.7878631330x+241.7933244655 R2=0.9963574043. The data values are indicated in Table 1.

The foregoing Detailed Description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements and that adaptations in the future may take into consideration of those advancements, namely in accordance with the then current state of the art. It is intended that the scope of the invention be defined by the Claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, component, or step is explicitly recited in the Claims. No claim element herein is to be construed under the provisions of 35 U.S.C. Sec. 112, sixth paragraph, unless the element is expressly recited using the phrase “means for . . . ” and no method or process step herein is to be construed under those provisions unless the step, or steps, are expressly recited using the phrase “comprising the step(s) of . . . . ”

TABLE 1

| | | | | | | | Ref- | | | | | | Dig. | | | |
|---|---|---|---|---|---|---|---|---|---|---|---|---|---|---|---|---|
| Thk | NRML REF | | Dig. | Film | Direct | | er- | | | | | | Mamo - | | | |
| mm | FORMULA | | Mamo | Mamo | X-ray | 50-100 | ence | | | | | | FRML | | | |
| 0.00 | | MAX | 255 | 249 | 249 | 251 | | 255 | 0 | 249 | 0 | #VALUE! y = −y = −9E−10 × 5 + 8E−07 × | | | | |
| | | | | | | | | | | | | 4 − 0.0003x3 + 0.0504x2 − 4.3855x + 175.99 | | | | |
| 0.00 | 1.00 | 1 | | | | | 255 | 0 | 0 | 0 | 0 | 242 | 176 | 249 | | 171.654601 |
| 0.02 | 0.99 | 2 | | | | | 253 | 0 | 0 | 0 | 0 | 242 | 176 | 0 | | 167.418213 |
| 0.05 | 0.99 | 3 | | | | | 252 | 0 | 0 | 0 | 0 | 242 | 176 | 0 | | 163.279065 |
| 0.07 | 0.98 | 4 | | | | | 250 | 0 | 0 | 0 | 0 | 242 | 176 | 0 | | 159.235404 |
| 0.09 | 0.98 | 5 | | | | | 249 | 0 | 0 | 0 | 0 | 242 | 176 | 0 | | 155.285497 |
| 0.12 | 0.97 | 6 | | | | | 247 | 0 | 0 | 0 | 0 | 242 | 175 | 0 | | 151.42763 |
| 0.14 | 0.96 | 7 | | | | | 246 | 0 | 0 | 0 | 0 | 242 | 175 | 0 | | 147.660106 |
| 0.17 | 0.96 | 8 | | | | | 244 | 0 | 0 | 0 | 0 | 241 | 175 | 0 | | 143.981247 |
| 0.19 | 0.95 | 9 | | | | | 243 | 0 | 0 | 0 | 0 | 241 | 175 | 0 | 0 | 140.389396 |
| 0.21 | 0.95 | 10 | | | | | 241 | 0 | 0 | 0 | 0 | 241 | 175 | 0 | 0 | 136.88291 |
| 0.24 | 0.94 | 11 | | | | | 240 | 0 | 0 | 0 | 0 | 241 | 175 | 0 | 0 | 133.460168 |
| 0.26 | 0.94 | 12 | | | | | 238 | 0 | 0 | 0 | 0 | 241 | 175 | 0 | 0 | 130.119565 |
| 0.28 | 0.93 | 13 | | | | | 237 | 0 | 0 | 0 | 0 | 241 | 175 | 0 | 0 | 126.859515 |
| 0.31 | 0.92 | 14 | | | | | 236 | 0 | 0 | 0 | 0 | 241 | 175 | 0 | 0 | 123.678449 |
| 0.33 | 0.92 | 15 | | | | | 234 | 0 | 0 | 0 | 0 | 241 | 175 | 0 | 0 | 120.574817 |
| 0.36 | 0.91 | 16 | | | | | 233 | 0 | 0 | 0 | 0 | 241 | 174 | 0 | 0 | 117.547085 |
| 0.38 | 0.91 | 17 | | | | | 231 | 0 | 0 | 0 | 0 | 241 | 174 | 0 | 0 | 114.593739 |
| 0.40 | 0.90 | 18 | | | | | 230 | 0 | 0 | 0 | 0 | 241 | 174 | 0 | 0 | 111.71328 |
| 0.43 | 0.90 | 19 | | | | | 228 | 0 | −218 | 0 | 0 | 241 | 174 | 0 | 0 | 108.904228 |
| 0.45 | 0.89 | 20 | | | | | 227 | 0 | 10 | 0 | −241 | 241 | 174 | 0 | 0 | 106.16512 |
| 0.48 | 0.88 | 21 | | | | | 225 | −106 | 6 | −213 | 4 | 241 | 174 | 0 | 0 | 103.494509 |
| 0.50 | 0.88 | 22 | 106 | 218 | 213 | 241 | 224 | 5 | 5 | 6 | 9 | 241 | 174 | −213 | 0 | 100.890967 |
| 0.52 | 0.87 | 23 | 101 | 208 | 207 | 237 | 223 | 1 | 3 | 2 | 4 | 241 | 174 | 6 | 0 | 98.3530801 |
| 0.55 | 0.87 | 24 | 100 | 202 | 205 | 228 | 221 | 3 | 5 | 5 | 5 | 241 | 174 | 2 | 0 | 95.8794544 |
| 0.57 | 0.86 | 25 | 97 | 197 | 200 | 224 | 220 | 3 | −1 | 5 | 6 | 241 | 173 | 5 | 0 | 93.4687109 |
| 0.60 | 0.86 | 26 | 94 | 194 | 195 | 219 | 218 | 3 | 0 | −2 | 4 | 241 | 173 | 5 | 0 | 91.1194876 |
| 0.62 | 0.85 | 27 | 91 | 189 | 197 | 213 | 217 | 3 | 4 | 0 | −2 | 241 | 173 | −2 | 0 | 88.8304388 |
| 0.64 | 0.85 | 28 | 88 | 190 | 197 | 209 | 215 | 4 | 5 | 10 | −4 | 241 | 173 | 0 | 0 | 86.6002355 |
| 0.67 | 0.84 | 29 | 84 | 190 | 187 | 211 | 214 | 2 | 4 | −1 | 5 | 241 | 173 | 10 | −241 | 84.4275648 |
| 0.69 | 0.83 | 30 | 82 | 186 | 188 | 215 | 213 | 1 | 6 | −3 | 2 | 241 | 173 | −1 | 4 | 82.31113 |
| 0.72 | 0.83 | 31 | 81 | 181 | 191 | 210 | 211 | 3 | 1 | 1 | 3 | 241 | 173 | −3 | 9 | 80.2496506 |
| 0.74 | 0.82 | 32 | 78 | 177 | 190 | 208 | 210 | 3 | 1 | 4 | −2 | 240 | 173 | 1 | 4 | 78.2418618 |
| 0.76 | 0.82 | 33 | 75 | 171 | 186 | 205 | 209 | 2 | 0 | 4 | 2 | 240 | 173 | 4 | 5 | 76.2865149 |
| 0.79 | 0.81 | 34 | 73 | 170 | 182 | 207 | 207 | 3 | 4 | −1 | 6 | 240 | 173 | 4 | 6 | 74.3823769 |
| 0.81 | 0.81 | 35 | 70 | 169 | 183 | 205 | 206 | 1 | −3 | −3 | 6 | 240 | 172 | −1 | 4 | 72.5282303 |
| 0.83 | 0.80 | 36 | 69 | 169 | 186 | 199 | 204 | 2 | 3 | 5 | 1 | 240 | 172 | −3 | −2 | 70.7228732 |
| 0.86 | 0.80 | 37 | 67 | 165 | 181 | 193 | 203 | 1 | 8 | 4 | −2 | 240 | 172 | 5 | −4 | 68.9651192 |
| 0.88 | 0.79 | 38 | 66 | 168 | 177 | 192 | 202 | 1 | 5 | 0 | 4 | 240 | 172 | 4 | 5 | 67.2537971 |
| 0.91 | 0.79 | 39 | 65 | 165 | 177 | 194 | 200 | 2 | −3 | 5 | 4 | 240 | 172 | 0 | 2 | 65.587751 |
| 0.93 | 0.78 | 40 | 63 | 157 | 172 | 190 | 199 | 2 | −1 | −6 | 3 | 240 | 172 | 5 | 3 | 63.96584 |
| 0.95 | 0.78 | 41 | 61 | 152 | 178 | 186 | 198 | 1 | 2 | 5 | 0 | 240 | 172 | −6 | −2 | 62.3869382 |
| 0.98 | 0.77 | 42 | 60 | 155 | 173 | 183 | 196 | 2 | 0 | 0 | −1 | 240 | 172 | 5 | 2 | 60.8499347 |
| 1.00 | 0.76 | 43 | 58 | 156 | 173 | 183 | 195 | 2 | 1 | 7 | 4 | 240 | 172 | 0 | 6 | 59.3537332 |
| 1.03 | 0.76 | 44 | 56 | 154 | 166 | 184 | 194 | 0 | 4 | 0 | 0 | 240 | 172 | 7 | 6 | 57.8972522 |
| 1.05 | 0.75 | 45 | 56 | 154 | 166 | 180 | 192 | 1 | 7 | −2 | −7 | 240 | 171 | 0 | 1 | 56.4794247 |
| 1.07 | 0.75 | 46 | 55 | 153 | 168 | 180 | 191 | 1 | 4 | 3 | 5 | 240 | 171 | −2 | −2 | 55.0991981 |
| 1.10 | 0.74 | 47 | 54 | 149 | 165 | 187 | 190 | 1 | 2 | 2 | 5 | 240 | 171 | 3 | 4 | 53.7555343 |
| 1.12 | 0.74 | 48 | 53 | 142 | 163 | 182 | 188 | 2 | 0 | 1 | 2 | 240 | 171 | 2 | 4 | 52.4474092 |
| 1.15 | 0.73 | 49 | 51 | 138 | 162 | 177 | 187 | 1 | −1 | −4 | 3 | 240 | 171 | 1 | 3 | 51.1738131 |
| 1.17 | 0.73 | 50 | 50 | 136 | 166 | 175 | 186 | 1 | 5 | 5 | 5 | 240 | 171 | −4 | 0 | 49.93375 |
| 1.19 | 0.72 | 51 | 49 | 136 | 161 | 172 | 184 | 1 | 1 | 5 | 4 | 240 | 171 | 5 | −1 | 48.7262381 |
| 1.22 | 0.72 | 52 | 48 | 137 | 156 | 167 | 183 | 1 | −1 | 2 | −3 | 240 | 171 | 5 | 4 | 47.5503092 |
| 1.24 | 0.71 | 53 | 47 | 132 | 154 | 163 | 182 | 2 | 2 | −1 | 0 | 240 | 171 | 2 | 0 | 46.4050089 |
| 1.26 | 0.71 | 54 | 45 | 131 | 155 | 166 | 181 | 0 | 3 | −5 | 3 | 240 | 171 | −1 | −7 | 45.2893963 |
| 1.29 | 0.70 | 55 | 45 | 132 | 160 | 166 | 179 | 0 | 2 | 0 | 3 | 239 | 170 | −5 | 5 | 44.2025441 |
| 1.31 | 0.70 | 56 | 45 | 130 | 160 | 163 | 178 | 1 | 7 | 2 | −2 | 239 | 170 | 0 | 5 | 43.1435382 |
| 1.34 | 0.69 | 57 | 44 | 127 | 158 | 160 | 177 | 1 | 3 | 7 | 5 | 239 | 170 | 2 | 2 | 42.1114779 |
| 1.36 | 0.69 | 58 | 43 | 125 | 151 | 162 | 175 | 0 | 1 | 3 | 6 | 239 | 170 | 7 | 3 | 41.1054757 |
| 1.38 | 0.68 | 59 | 43 | 118 | 148 | 157 | 174 | 1 | 7 | −1 | −2 | 239 | 170 | 3 | 5 | 40.1246569 |
| 1.41 | 0.68 | 60 | 42 | 115 | 149 | 151 | 173 | 1 | 2 | 7 | 3 | 239 | 170 | −1 | 4 | 39.16816 |
| 1.43 | 0.67 | 61 | 41 | 114 | 142 | 153 | 172 | 0 | −5 | 2 | 4 | 239 | 170 | 7 | −3 | 38.2351361 |
| 1.46 | 0.67 | 62 | 41 | 107 | 140 | 150 | 170 | 0 | −3 | −10 | 0 | 239 | 170 | 2 | 0 | 37.3247493 |
| 1.48 | 0.66 | 63 | 41 | 105 | 150 | 146 | 169 | 1 | 2 | 11 | −4 | 239 | 170 | −10 | 3 | 36.4361759 |
| 1.50 | 0.66 | 64 | 40 | 110 | 139 | 146 | 168 | 2 | 3 | −6 | 8 | 239 | 170 | 11 | 3 | 35.5686052 |
| 1.53 | 0.65 | 65 | 38 | 113 | 145 | 150 | 167 | 1 | 1 | 5 | −1 | 239 | 169 | −6 | −2 | 34.7212384 |
| 1.55 | 0.65 | 66 | 37 | 111 | 140 | 142 | 165 | 0 | 2 | 5 | 0 | 239 | 169 | 5 | 5 | 33.8932895 |
| 1.58 | 0.64 | 67 | 37 | 108 | 135 | 143 | 164 | 0 | 0 | −6 | 5 | 239 | 169 | 5 | 6 | 33.0839842 |
| 1.60 | 0.64 | 68 | 37 | 107 | 141 | 143 | 163 | 1 | 4 | 0 | −7 | 239 | 169 | −6 | −2 | 32.2925606 |
| 1.62 | 0.63 | 69 | 36 | 105 | 141 | 138 | 162 | 0 | 6 | 9 | 3 | 239 | 169 | 0 | 3 | 31.5182686 |
| 1.65 | 0.63 | 70 | 36 | 105 | 132 | 145 | 161 | 0 | −4 | 3 | 5 | 239 | 169 | 9 | 4 | 30.76037 |
| 1.67 | 0.62 | 71 | 36 | 101 | 129 | 142 | 159 | 1 | 1 | 2 | 7 | 239 | 169 | 3 | 0 | 30.0181384 |
| 1.69 | 0.62 | 72 | 35 | 95 | 127 | 137 | 158 | 0 | 7 | −5 | 2 | 239 | 169 | 2 | −4 | 29.2908589 |
| 1.72 | 0.62 | 73 | 35 | 99 | 132 | 130 | 157 | 0 | 3 | 0 | 2 | 239 | 169 | −5 | 8 | 28.5778284 |
| 1.74 | 0.61 | 74 | 35 | 98 | 132 | 128 | 156 | 1 | −3 | 6 | 1 | 239 | 168 | 0 | −1 | 27.8783548 |
| 1.77 | 0.61 | 75 | 34 | 91 | 126 | 126 | 155 | 1 | −3 | −4 | −1 | 239 | 168 | 6 | 0 | 27.1917578 |
| 1.79 | 0.60 | 76 | 33 | 88 | 130 | 125 | 153 | 0 | 0 | 7 | −2 | 239 | 168 | −4 | 5 | 26.517368 |
| 1.81 | 0.60 | 77 | 33 | 91 | 123 | 126 | 152 | 0 | 6 | −5 | 5 | 239 | 168 | 7 | −7 | 25.8545271 |
| 1.84 | 0.59 | 78 | 33 | 94 | 128 | 128 | 151 | 1 | −1 | 2 | 5 | 239 | 168 | −5 | 3 | 25.2025879 |
| 1.86 | 0.59 | 79 | 32 | 94 | 126 | 123 | 150 | 1 | 1 | 4 | −3 | 238 | 168 | 2 | 5 | 24.560914 |
| 1.89 | 0.58 | 80 | 31 | 88 | 122 | 118 | 149 | 1 | 8 | 2 | 0 | 238 | 168 | 4 | 7 | 23.92888 |
| 1.91 | 0.58 | 81 | 30 | 89 | 120 | 121 | 147 | 0 | −1 | 4 | 0 | 238 | 168 | 2 | 2 | 23.3058708 |
| 1.93 | 0.57 | 82 | 30 | 88 | 116 | 121 | 146 | 0 | 4 | −3 | 3 | 238 | 168 | 4 | 2 | 22.6912822 |
| 1.96 | 0.57 | 83 | 30 | 80 | 119 | 121 | 145 | 0 | 2 | 1 | 4 | 238 | 168 | −3 | 1 | 22.0845202 |
| 1.98 | 0.56 | 84 | 30 | 81 | 118 | 118 | 144 | 1 | −2 | 1 | −1 | 238 | 167 | 1 | −1 | 21.4850013 |
| 2.01 | 0.56 | 85 | 29 | 77 | 117 | 114 | 143 | 0 | 3 | 3 | 2 | 238 | 167 | 1 | −2 | 20.8921522 |
| 2.03 | 0.56 | 86 | 29 | 75 | 114 | 115 | 142 | 0 | 2 | −4 | 3 | 238 | 167 | 3 | 5 | 20.3054096 |
| 2.05 | 0.55 | 87 | 29 | 77 | 118 | 113 | 141 | 0 | −1 | 6 | 3 | 238 | 167 | −4 | 5 | 19.7242205 |
| 2.08 | 0.55 | 88 | 29 | 74 | 112 | 110 | 139 | 0 | 2 | 3 | 2 | 238 | 167 | 6 | −3 | 19.1480415 |
| 2.10 | 0.54 | 89 | 29 | 72 | 109 | 107 | 138 | 0 | 2 | −3 | 1 | 238 | 167 | 3 | 0 | 18.5763393 |
| 2.12 | 0.54 | 90 | 29 | 73 | 112 | 105 | 137 | 1 | 3 | 6 | −3 | 238 | 167 | −3 | 0 | 18.00859 |
| 2.15 | 0.53 | 91 | 28 | 71 | 106 | 104 | 136 | 1 | 1 | −8 | 4 | 238 | 167 | 6 | 3 | 17.4442795 |
| 2.17 | 0.53 | 92 | 27 | 69 | 114 | 107 | 135 | 0 | −1 | 4 | 3 | 238 | 167 | −8 | 4 | 16.8829031 |
| 2.20 | 0.52 | 93 | 27 | 66 | 110 | 103 | 134 | 0 | 3 | 10 | −5 | 238 | 167 | 4 | −1 | 16.3239655 |
| 2.22 | 0.52 | 94 | 27 | 65 | 100 | 100 | 133 | 0 | −1 | −3 | 1 | 238 | 166 | 10 | 2 | 15.7669806 |
| 2.24 | 0.52 | 95 | 27 | 66 | 103 | 105 | 132 | 0 | 1 | 1 | 9 | 238 | 166 | −3 | 3 | 15.2114716 |
| 2.27 | 0.51 | 96 | 27 | 63 | 102 | 104 | 130 | 1 | 3 | 0 | 1 | 238 | 166 | 1 | 3 | 14.6569705 |
| 2.29 | 0.51 | 97 | 26 | 64 | 102 | 95 | 129 | 0 | 2 | 0 | −3 | 238 | 166 | 0 | 2 | 14.1030186 |
| 2.32 | 0.50 | 98 | 26 | 63 | 102 | 94 | 128 | 0 | 0 | 5 | 5 | 238 | 166 | 0 | 1 | 13.5491656 |
| 2.34 | 0.50 | 99 | 26 | 60 | 97 | 97 | 127 | 1 | −1 | −2 | −1 | 238 | 166 | 5 | −3 | 12.9949704 |
| 2.36 | 0.49 | 100 | 25 | 58 | 99 | 92 | 126 | 0 | 2 | −2 | 2 | 238 | 166 | −2 | 4 | 12.44 |
| 2.39 | 0.49 | 101 | 25 | 58 | 101 | 93 | 125 | 0 | 1 | 4 | 5 | 238 | 166 | −2 | 3 | 11.8838303 |
| 2.41 | 0.49 | 102 | 25 | 59 | 97 | 91 | 124 | 0 | 1 | −4 | 1 | 238 | 166 | 4 | −5 | 11.3260456 |
| 2.44 | 0.48 | 103 | 25 | 57 | 101 | 86 | 123 | 0 | 1 | 0 | 2 | 237 | 166 | −4 | 1 | 10.7662381 |
| 2.46 | 0.48 | 104 | 25 | 56 | 101 | 85 | 122 | −1 | 2 | 8 | 2 | 237 | 166 | 0 | 9 | 10.2040087 |
| 2.48 | 0.47 | 105 | 26 | 55 | 93 | 83 | 121 | 1 | 1 | 1 | 2 | 237 | 165 | 8 | 1 | 9.63896594 |
| 2.51 | 0.47 | 106 | 25 | 54 | 92 | 81 | 120 | 1 | 1 | 0 | 0 | 237 | 165 | 1 | −3 | 9.0707266 |
| 2.53 | 0.47 | 107 | 24 | 52 | 92 | 79 | 119 | 0 | 2 | −1 | −2 | 237 | 165 | 0 | 5 | 8.49891522 |
| 2.56 | 0.46 | 108 | 24 | 51 | 93 | 79 | 118 | 0 | −1 | 1 | −2 | 237 | 165 | −1 | −1 | 7.92316411 |
| 2.58 | 0.46 | 109 | 24 | 50 | 92 | 81 | 117 | 0 | 3 | 3 | 3 | 237 | 165 | 1 | 2 | 7.34311321 |
| 2.60 | 0.45 | 110 | 24 | 48 | 89 | 83 | 116 | 0 | −1 | 2 | 0 | 237 | 165 | 3 | 5 | 6.75841 |
| 2.63 | 0.45 | 111 | 24 | 49 | 87 | 80 | 115 | 1 | −4 | 3 | 1 | 237 | 165 | 2 | 1 | 6.1687094 |
| 2.65 | 0.45 | 112 | 23 | 46 | 84 | 80 | 113 | 1 | 0 | −2 | 3 | 237 | 165 | 3 | 2 | 5.57367365 |
| 2.67 | 0.44 | 113 | 22 | 47 | 86 | 79 | 112 | −1 | 8 | 4 | −2 | 237 | 165 | −2 | 2 | 4.97297219 |
| 2.70 | 0.44 | 114 | 23 | 51 | 82 | 76 | 111 | −1 | 0 | 0 | 0 | 237 | 165 | 4 | 2 | 4.36628156 |
| 2.72 | 0.43 | 115 | 24 | 51 | 82 | 78 | 110 | 1 | 2 | 3 | 4 | 237 | 164 | 0 | 0 | 3.75328531 |
| 2.75 | 0.43 | 116 | 23 | 43 | 79 | 78 | 109 | 0 | 2 | −5 | 2 | 237 | 164 | 3 | −2 | 3.13367388 |
| 2.77 | 0.43 | 117 | 23 | 43 | 84 | 74 | 108 | −1 | 0 | −1 | 4 | 237 | 164 | −5 | −2 | 2.50714448 |
| 2.79 | 0.42 | 118 | 24 | 41 | 85 | 72 | 107 | 1 | −1 | 1 | 1 | 237 | 164 | −1 | 3 | 1.87340099 |
| 2.82 | 0.42 | 119 | 23 | 39 | 84 | 68 | 106 | 1 | 0 | −2 | −2 | 237 | 164 | 1 | 0 | 1.23215386 |
| 2.84 | 0.41 | 120 | 22 | 39 | 86 | 67 | 105 | 0 | −4 | 6 | 0 | 237 | 164 | −2 | 1 | 0.58312 |
| 2.87 | 0.41 | 121 | 22 | 40 | 80 | 69 | 104 | 0 | 5 | 8 | 0 | 237 | 164 | 6 | 3 | −0.07397734 |
| 2.89 | 0.41 | 122 | 22 | 40 | 72 | 69 | 103 | 0 | 2 | 5 | 1 | 237 | 164 | 8 | −2 | −0.73940867 |
| 2.91 | 0.40 | 123 | 22 | 44 | 67 | 69 | 102 | 1 | −4 | −4 | 2 | 237 | 164 | 5 | 0 | −1.41343836 |
| 2.94 | 0.40 | 124 | 21 | 39 | 71 | 68 | 101 | 0 | 2 | −2 | −1 | 237 | 164 | −4 | 4 | −2.09632476 |
| 2.96 | 0.39 | 125 | 21 | 37 | 73 | 66 | 101 | 0 | −1 | 4 | 1 | 237 | 163 | −2 | 2 | −2.78832031 |
| 2.99 | 0.39 | 126 | 21 | 41 | 69 | 67 | 100 | −1 | 1 | −1 | 3 | 236 | 163 | 4 | 4 | −3.48967164 |
| 3.01 | 0.39 | 127 | 22 | 39 | 70 | 66 | 99 | 1 | 5 | 1 | 4 | 236 | 163 | −1 | 1 | −4.20061967 |
| 3.03 | 0.38 | 128 | 21 | 40 | 69 | 63 | 98 | 0 | −3 | 0 | 2 | 236 | 163 | 1 | −2 | −4.92139973 |
| 3.06 | 0.38 | 129 | 21 | 39 | 69 | 59 | 97 | 1 | 1 | −1 | −2 | 236 | 163 | 0 | 0 | −5.65224168 |
| 3.08 | 0.38 | 130 | 20 | 34 | 70 | 57 | 96 | 0 | 1 | −2 | −3 | 236 | 163 | −1 | 0 | −6.39337 |
| 3.10 | 0.37 | 131 | 20 | 37 | 72 | 59 | 95 | −1 | 4 | 0 | −2 | 236 | 163 | −2 | 1 | −7.14500389 |
| 3.13 | 0.37 | 132 | 21 | 36 | 72 | 62 | 94 | 1 | 2 | 4 | 6 | 236 | 163 | 0 | 2 | −7.90735739 |
| 3.15 | 0.36 | 133 | 20 | 35 | 68 | 64 | 93 | −1 | 3 | −1 | 5 | 236 | 163 | 4 | −1 | −8.6806395 |
| 3.18 | 0.36 | 134 | 21 | 31 | 69 | 58 | 92 | 0 | −10 | 1 | 1 | 236 | 163 | −1 | 1 | −9.46505428 |
| 3.20 | 0.36 | 135 | 21 | 29 | 68 | 53 | 91 | 2 | 5 | 4 | −3 | 236 | 162 | 1 | 3 | −10.2608009 |
| 3.22 | 0.35 | 136 | 19 | 26 | 64 | 52 | 90 | 1 | 0 | 3 | −2 | 236 | 162 | 4 | 4 | −11.068074 |
| 3.25 | 0.35 | 137 | 18 | 36 | 61 | 55 | 89 | −2 | 2 | 1 | 4 | 236 | 162 | 3 | 2 | −11.8870632 |
| 3.27 | 0.35 | 138 | 20 | 31 | 60 | 57 | 88 | 0 | 0 | −1 | 3 | 236 | 162 | 1 | −2 | −12.7179541 |
| 3.30 | 0.34 | 139 | 20 | 31 | 61 | 53 | 87 | 0 | 2 | −5 | 0 | 236 | 162 | −1 | −3 | −13.5609274 |
| 3.32 | 0.34 | 140 | 20 | 29 | 66 | 50 | 86 | 0 | −2 | −3 | 1 | 236 | 162 | −5 | −2 | −14.41616 |
| 3.34 | 0.34 | 141 | 20 | 29 | 69 | 50 | 86 | 0 | 2 | 2 | 4 | 236 | 162 | −3 | 6 | −15.2838242 |
| 3.37 | 0.33 | 142 | 20 | 27 | 67 | 49 | 85 | 0 | −8 | 1 | 1 | 236 | 162 | 2 | 5 | −16.1640885 |
| 3.39 | 0.33 | 143 | 20 | 29 | 66 | 45 | 84 | 1 | 7 | 3 | −4 | 236 | 162 | 1 | 1 | −17.0571172 |
| 3.42 | 0.33 | 144 | 19 | 27 | 63 | 44 | 83 | 0 | −1 | 4 | −3 | 236 | 162 | 3 | −3 | −17.963071 |
| 3.44 | 0.32 | 145 | 19 | 35 | 59 | 48 | 82 | −1 | 1 | 6 | 1 | 236 | 161 | 4 | −2 | −18.8821066 |
| 3.46 | 0.32 | 146 | 20 | 28 | 53 | 51 | 81 | 0 | 5 | −2 | 0 | 236 | 161 | 6 | 4 | −19.8143771 |
| 3.49 | 0.31 | 147 | 20 | 29 | 55 | 50 | 80 | 0 | −2 | 3 | 3 | 236 | 161 | −2 | 3 | −20.7600322 |
| 3.51 | 0.31 | 148 | 20 | 28 | 52 | 50 | 79 | 1 | 4 | −2 | 3 | 236 | 161 | 3 | 0 | −21.719218 |
| 3.53 | 0.31 | 149 | 19 | 23 | 54 | 47 | 79 | 0 | −3 | −4 | −3 | 236 | 161 | −2 | 1 | −22.6920774 |
| 3.56 | 0.30 | 150 | 19 | 25 | 58 | 44 | 78 | −1 | 1 | 7 | 2 | 235 | 161 | −4 | 4 | −23.67875 |
| 3.58 | 0.30 | 151 | 20 | 21 | 51 | 47 | 77 | 2 | 2 | −9 | 2 | 235 | 161 | 7 | 1 | −24.6793724 |
| 3.61 | 0.30 | 152 | 18 | 24 | 60 | 45 | 76 | 0 | −3 | 6 | −6 | 235 | 161 | −9 | −4 | −25.694078 |
| 3.63 | 0.29 | 153 | 18 | 23 | 54 | 43 | 75 | −1 | 5 | −2 | 3 | 235 | 161 | 6 | −3 | −26.7229976 |
| 3.65 | 0.29 | 154 | 19 | 21 | 56 | 49 | 74 | −1 | −1 | 6 | 10 | 235 | 161 | −2 | 1 | −27.7662589 |
| 3.68 | 0.29 | 155 | 20 | 24 | 50 | 46 | 73 | 0 | 1 | 3 | 1 | 235 | 161 | 6 | 0 | −28.8239872 |
| 3.70 | 0.28 | 156 | 20 | 19 | 47 | 36 | 73 | 2 | 0 | 0 | −9 | 235 | 160 | 3 | 3 | −29.896305 |
| 3.73 | 0.28 | 157 | 18 | 20 | 47 | 35 | 72 | −1 | −2 | −9 | 1 | 235 | 160 | 0 | 3 | −30.9833325 |
| 3.75 | 0.28 | 158 | 19 | 19 | 56 | 44 | 71 | 1 | 2 | 3 | 10 | 235 | 160 | −9 | −3 | −32.0851875 |
| 3.77 | 0.27 | 159 | 18 | 19 | 53 | 43 | 70 | 0 | 1 | 6 | 0 | 235 | 160 | 3 | 2 | −33.2019855 |
| 3.80 | 0.27 | 160 | 18 | 21 | 47 | 33 | 69 | 0 | −5 | 4 | −2 | 235 | 160 | 6 | 2 | −34.33384 |
| 3.82 | 0.27 | 161 | 18 | 19 | 43 | 33 | 68 | 0 | 3 | 6 | 0 | 235 | 160 | 4 | −6 | −35.4808623 |
| 3.85 | 0.27 | 162 | 18 | 18 | 37 | 35 | 68 | −1 | 2 | −6 | −2 | 235 | 160 | 6 | 3 | −36.6431619 |
| 3.87 | 0.26 | 163 | 19 | 23 | 43 | 35 | 67 | 1 | 1 | −5 | 0 | 235 | 160 | −6 | 10 | −37.8208465 |
| 3.89 | 0.26 | 164 | 18 | 20 | 48 | 37 | 66 | 1 | −2 | −1 | 1 | 235 | 160 | −5 | 1 | −39.014022 |
| 3.92 | 0.26 | 165 | 17 | 18 | 49 | 37 | 65 | −1 | 1 | 7 | 0 | 235 | 160 | −1 | −9 | −40.2227928 |
| 3.94 | 0.25 | 166 | 18 | 17 | 42 | 36 | 65 | 0 | 0 | −2 | 2 | 235 | 159 | 7 | 1 | −41.4472617 |
| 3.97 | 0.25 | 167 | 18 | 19 | 44 | 36 | 64 | 1 | −1 | −6 | 2 | 235 | 159 | −2 | 10 | −42.6875302 |
| 3.99 | 0.25 | 168 | 17 | 18 | 50 | 34 | 63 | 0 | 3 | 9 | 0 | 235 | 159 | −6 | 0 | −43.9436986 |
| 4.01 | 0.24 | 169 | 17 | 18 | 41 | 32 | 62 | −1 | 3 | 5 | 2 | 235 | 159 | 9 | −2 | −45.2158659 |
| 4.04 | 0.24 | 170 | 18 | 19 | 36 | 32 | 61 | 1 | −2 | −3 | 1 | 235 | 159 | 5 | 0 | −46.50413 |
| 4.06 | 0.24 | 171 | 17 | 16 | 39 | 30 | 61 | −1 | −1 | −5 | −2 | 235 | 159 | −3 | −2 | −47.8085881 |
| 4.08 | 0.23 | 172 | 18 | 13 | 44 | 29 | 60 | 1 | 0 | 5 | −2 | 235 | 159 | −5 | 0 | −49.1293363 |
| 4.11 | 0.23 | 173 | 17 | 15 | 39 | 31 | 59 | 0 | 0 | 0 | 0 | 235 | 159 | 5 | 1 | −50.4664701 |
| 4.13 | 0.23 | 174 | 17 | 16 | 39 | 33 | 58 | 0 | −1 | 2 | 3 | 234 | 159 | 0 | 0 | −51.8200844 |
| 4.16 | 0.23 | 175 | 17 | 16 | 37 | 33 | 58 | −1 | 5 | −1 | 1 | 234 | 159 | 2 | 2 | −53.1902734 |
| 4.18 | 0.22 | 176 | 18 | 16 | 38 | 30 | 57 | 1 | −2 | 2 | −1 | 234 | 159 | −1 | 2 | −54.5771312 |
| 4.20 | 0.22 | 177 | 17 | 17 | 36 | 29 | 56 | −1 | 2 | 1 | 2 | 234 | 158 | 2 | 0 | −55.9807514 |
| 4.23 | 0.22 | 178 | 18 | 12 | 35 | 30 | 55 | 1 | 0 | −2 | 5 | 234 | 158 | 1 | 2 | −57.4012273 |
| 4.25 | 0.21 | 179 | 17 | 14 | 37 | 28 | 55 | 1 | 0 | 2 | −3 | 234 | 158 | −2 | 1 | −58.8386524 |
| 4.28 | 0.21 | 180 | 16 | 12 | 35 | 23 | 54 | −1 | −1 | −2 | −1 | 234 | 158 | 2 | −2 | −60.29312 |
| 4.30 | 0.21 | 181 | 17 | 12 | 37 | 26 | 53 | 0 | −2 | 1 | 4 | 234 | 158 | −2 | −2 | −61.7647236 |
| 4.32 | 0.21 | 182 | 17 | 12 | 36 | 27 | 52 | 1 | 1 | 6 | −1 | 234 | 158 | 1 | 0 | −63.253557 |
| 4.35 | 0.20 | 183 | 16 | 13 | 30 | 23 | 52 | −1 | 1 | −1 | 0 | 234 | 158 | 6 | 3 | −64.7597142 |
| 4.37 | 0.20 | 184 | 17 | 15 | 31 | 24 | 51 | 1 | 3 | −12 | 0 | 234 | 158 | −1 | 1 | −66.2832899 |
| 4.40 | 0.20 | 185 | 16 | 14 | 43 | 24 | 50 | 0 | 0 | 0 | 2 | 234 | 158 | −12 | −1 | −67.8243791 |
| 4.42 | 0.19 | 186 | 16 | 13 | 43 | 24 | 50 | 0 | −2 | 9 | −3 | 234 | 158 | 0 | 2 | −69.3830776 |
| 4.44 | 0.19 | 187 | 16 | 10 | 34 | 22 | 49 | −1 | 2 | 6 | −5 | 234 | 157 | 9 | 5 | −70.9594819 |
| 4.47 | 0.19 | 188 | 17 | 10 | 28 | 25 | 48 | 0 | 1 | 2 | 6 | 234 | 157 | 6 | −3 | −72.5536897 |
| 4.49 | 0.19 | 189 | 17 | 12 | 26 | 30 | 48 | 0 | 0 | −1 | 6 | 234 | 157 | 2 | −1 | −74.1657992 |
| 4.51 | 0.18 | 190 | 17 | 10 | 27 | 24 | 47 | 1 | −5 | −2 | −2 | 234 | 157 | −1 | 4 | −75.79591 |
| 4.54 | 0.18 | 191 | 16 | 9 | 29 | 18 | 46 | 0 | 2 | −4 | −1 | 234 | 157 | −2 | −1 | −77.444123 |
| 4.56 | 0.18 | 192 | 16 | 9 | 33 | 20 | 46 | −1 | 1 | 1 | 1 | 234 | 157 | −4 | 0 | −79.1105401 |
| 4.59 | 0.18 | 193 | 17 | 14 | 32 | 21 | 45 | 0 | −2 | 2 | 1 | 234 | 157 | 1 | 0 | −80.795265 |
| 4.61 | 0.17 | 194 | 17 | 12 | 30 | 20 | 44 | 1 | 0 | 2 | −4 | 234 | 157 | 2 | 2 | −82.4984026 |
| 4.63 | 0.17 | 195 | 16 | 11 | 28 | 19 | 44 | 0 | −1 | −9 | 1 | 234 | 157 | 2 | −3 | −84.2200597 |
| 4.66 | 0.17 | 196 | 16 | 13 | 37 | 23 | 43 | −1 | 2 | −2 | 3 | 234 | 157 | −9 | −5 | −85.9603447 |
| 4.68 | 0.17 | 197 | 17 | 13 | 39 | 22 | 42 | 1 | 3 | 10 | 0 | 234 | 157 | −2 | 6 | −87.7193679 |
| 4.71 | 0.16 | 198 | 16 | 14 | 29 | 19 | 42 | 0 | 2 | 3 | 2 | 233 | 156 | 10 | 6 | −89.4972416 |
| 4.73 | 0.16 | 199 | 16 | 12 | 26 | 19 | 41 | 0 | −4 | 1 | 2 | 233 | 156 | 3 | −2 | −91.2940801 |
| 4.75 | 0.16 | 200 | 16 | 9 | 25 | 17 | 40 | 0 | −1 | 1 | 2 | 233 | 156 | 1 | −1 | −93.11 |
| 4.78 | 0.16 | 201 | 16 | 7 | 24 | 15 | 40 | 0 | 2 | 4 | −2 | 233 | 156 | 1 | 1 | −94.9451201 |
| 4.80 | 0.15 | 202 | 16 | 11 | 20 | 13 | 39 | 0 | 0 | 1 | 2 | 233 | 156 | 4 | 1 | −96.7995616 |
| 4.83 | 0.15 | 203 | 16 | 12 | 19 | 15 | 38 | −1 | −1 | −7 | 4 | 233 | 156 | 1 | −4 | −98.6734483 |
| 4.85 | 0.15 | 204 | 17 | 10 | 26 | 13 | 38 | 2 | 1 | 1 | −1 | 233 | 156 | −7 | 1 | −100.566907 |
| 4.87 | 0.15 | 205 | 15 | 10 | 25 | 9 | 37 | −1 | 0 | 2 | −3 | 233 | 156 | 1 | 3 | −102.480065 |
| 4.90 | 0.14 | 206 | 16 | 11 | 23 | 10 | 37 | 1 | 0 | −2 | −4 | 233 | 156 | 2 | 0 | −104.413057 |
| 4.92 | 0.14 | 207 | 15 | 10 | 25 | 13 | 36 | 0 | 0 | 3 | 0 | 233 | 156 | −2 | 2 | −106.366015 |
| 4.94 | 0.14 | 208 | 15 | 10 | 22 | 17 | 35 | −1 | −1 | 1 | 2 | 233 | 156 | 3 | 2 | −108.339079 |
| 4.97 | 0.14 | 209 | 16 | 10 | 21 | 17 | 35 | 0 | 0 | 2 | 0 | 233 | 155 | 1 | 2 | −110.332389 |
| 4.99 | 0.13 | 210 | 16 | 10 | 19 | 15 | 34 | −1 | 3 | 2 | 2 | 233 | 155 | 2 | −2 | −112.34609 |
| 5.02 | 0.13 | 211 | 17 | 11 | 17 | 15 | 34 | 2 | 1 | −5 | 0 | 233 | 155 | 2 | 2 | −114.380329 |
| 5.04 | 0.13 | 212 | 15 | 11 | 22 | 13 | 33 | −1 | 1 | −1 | 0 | 233 | 155 | −5 | 4 | −116.435258 |
| 5.06 | 0.13 | 213 | 16 | 8 | 23 | 13 | 32 | 0 | −2 | 2 | 3 | 233 | 155 | −1 | −1 | −118.51103 |
| 5.09 | 0.12 | 214 | 16 | 7 | 21 | 13 | 32 | 0 | −1 | 0 | 0 | 233 | 155 | 2 | −3 | −120.607806 |
| 5.11 | 0.12 | 215 | 16 | 6 | 21 | 10 | 31 | 0 | −2 | 2 | 0 | 233 | 155 | 0 | −4 | −122.725746 |
| 5.14 | 0.12 | 216 | 16 | 8 | 19 | 10 | 31 | 0 | 0 | 1 | 0 | 233 | 155 | 2 | 0 | −124.865017 |
| 5.16 | 0.12 | 217 | 16 | 9 | 18 | 10 | 30 | 0 | 1 | 0 | 1 | 233 | 155 | 1 | 2 | −127.02579 |
| 5.18 | 0.12 | 218 | 16 | 11 | 18 | 10 | 30 | 0 | 2 | 2 | −1 | 233 | 155 | 0 | 0 | −129.208238 |
| 5.21 | 0.11 | 219 | 16 | 11 | 16 | 9 | 29 | 1 | 0 | 0 | −4 | 233 | 154 | 2 | 2 | −131.412541 |
| 5.23 | 0.11 | 220 | 15 | 10 | 16 | 10 | 29 | 0 | −1 | −1 | 1 | 233 | 154 | 0 | 0 | −133.63888 |
| 5.26 | 0.11 | 221 | 15 | 8 | 17 | 14 | 28 | 0 | 1 | 1 | −2 | 233 | 154 | −1 | 0 | −135.887444 |
| 5.28 | 0.11 | 222 | 15 | 8 | 16 | 13 | 27 | 0 | 3 | 1 | −3 | 232 | 154 | 1 | 3 | −138.158424 |
| 5.30 | 0.11 | 223 | 15 | 9 | 15 | 15 | 27 | 0 | 1 | 0 | 6 | 232 | 154 | 1 | 0 | −140.452017 |
| 5.33 | 0.10 | 224 | 15 | 8 | 15 | 18 | 26 | −1 | −1 | −2 | −1 | 232 | 154 | 0 | 0 | −142.768424 |
| 5.35 | 0.10 | 225 | 16 | 5 | 17 | 12 | 26 | 1 | −1 | −4 | 3 | 232 | 154 | −2 | 0 | −145.107852 |
| 5.37 | 0.10 | 226 | 15 | 4 | 21 | 13 | 25 | 0 | 1 | 5 | 3 | 232 | 154 | −4 | 1 | −147.470511 |
| 5.40 | 0.10 | 227 | 15 | 5 | 16 | 10 | 25 | 0 | 0 | 4 | −1 | 232 | 154 | 5 | −1 | −149.856618 |
| 5.42 | 0.10 | 228 | 15 | 6 | 12 | 7 | 24 | 1 | 0 | −2 | −4 | 232 | 154 | 4 | −4 | −152.266395 |
| 5.45 | 0.09 | 229 | 14 | 5 | 14 | 8 | 24 | −1 | −1 | 2 | 5 | 232 | 154 | −2 | 1 | −154.700068 |
| 5.47 | 0.09 | 230 | 15 | 5 | 12 | 12 | 23 | −1 | −1 | −3 | 1 | 232 | 153 | 2 | −2 | −157.15787 |
| 5.49 | 0.09 | 231 | 16 | 5 | 15 | 7 | 23 | 1 | 2 | 0 | 0 | 232 | 153 | −3 | −3 | −159.640038 |
| 5.52 | 0.09 | 232 | 15 | 6 | 15 | 6 | 22 | 0 | 0 | 4 | −8 | 232 | 153 | 0 | 6 | −162.146817 |
| 5.54 | 0.09 | 233 | 15 | 7 | 11 | 6 | 22 | 0 | 0 | −1 | 6 | 232 | 153 | 4 | −1 | −164.678454 |
| 5.57 | 0.08 | 234 | 15 | 5 | 12 | 14 | 21 | −1 | 2 | −1 | 1 | 232 | 153 | −1 | 3 | −167.235205 |
| 5.59 | 0.08 | 235 | 16 | 5 | 13 | 8 | 21 | 1 | −1 | 1 | 2 | 232 | 153 | −1 | 3 | −169.817332 |
| 5.61 | 0.08 | 236 | 15 | 5 | 12 | 7 | 20 | 0 | −1 | 2 | 0 | 232 | 153 | 1 | −1 | −172.425101 |
| 5.64 | 0.08 | 237 | 15 | 3 | 10 | 5 | 20 | 0 | 1 | −2 | −3 | 232 | 153 | 2 | −4 | −175.058786 |
| 5.66 | 0.08 | 238 | 15 | 4 | 12 | 5 | 19 | 0 | 0 | 0 | 0 | 232 | 153 | −2 | 5 | −177.718665 |
| 5.69 | 0.07 | 239 | 15 | 5 | 12 | 8 | 19 | 1 | −1 | 4 | −1 | 232 | 153 | 0 | 1 | −180.405026 |
| 5.71 | 0.07 | 240 | 14 | 4 | 8 | 8 | 18 | −1 | 1 | −4 | −1 | 232 | 153 | 4 | 0 | −183.11816 |
| 5.73 | 0.07 | 241 | 15 | 4 | 12 | 9 | 18 | 0 | 2 | −2 | 4 | 232 | 152 | −4 | −8 | −185.858367 |
| 5.76 | 0.07 | 242 | 15 | 5 | 14 | 10 | 18 | −1 | −1 | 5 | −1 | 232 | 152 | −2 | 6 | −188.625952 |
| 5.78 | 0.07 | 243 | 16 | 4 | 9 | 6 | 17 | 1 | −1 | 3 | −2 | 232 | 152 | 5 | 1 | −191.421228 |
| 5.81 | 0.07 | 244 | 15 | 2 | 6 | 7 | 17 | −1 | 0 | 0 | 2 | 232 | 152 | 3 | 2 | −194.244514 |
| 5.83 | 0.06 | 245 | 16 | 3 | 6 | 9 | 16 | 0 | −1 | 1 | 2 | 232 | 152 | 0 | 0 | −197.096138 |
| 5.85 | 0.06 | 246 | 16 | 4 | 5 | 7 | 16 | 1 | −2 | −6 | −2 | 231 | 152 | 1 | −3 | −199.976432 |
| 5.88 | 0.06 | 247 | 15 | 4 | 11 | 5 | 15 | 0 | 1 | −5 | 2 | 231 | 152 | −6 | 0 | −202.885739 |
| 5.90 | 0.06 | 248 | 15 | 5 | 16 | 7 | 15 | −1 | 5 | 3 | −2 | 231 | 152 | −5 | −1 | −205.824405 |
| 5.92 | 0.06 | 249 | 16 | 7 | 13 | 5 | 15 | 1 | −1 | −1 | 3 | 231 | 152 | 3 | −1 | −208.792788 |
| 5.95 | 0.06 | 250 | 15 | 6 | 14 | 7 | 14 | 0 | −2 | 0 | 0 | 231 | 152 | −1 | 4 | −211.79125 |
| 5.97 | 0.05 | 251 | 15 | 1 | 14 | 4 | 14 | 0 | 0 | 3 | −4 | 231 | 152 | 0 | −1 | −214.820163 |
| 6.00 | 0.05 | 252 | 15 | 2 | 11 | 4 | 13 | 0 | −1 | −1 | 1 | 231 | 151 | 3 | −2 | −217.879905 |
| 6.02 | 0.05 | 253 | 15 | 4 | 12 | 8 | 13 | 0 | −2 | 1 | 3 | 231 | 151 | −1 | 2 | −220.970864 |
| 6.04 | 0.05 | 254 | 15 | 4 | 11 | 7 | 13 | 0 | 5 | −1 | −5 | 231 | 151 | 1 | 2 | −224.093434 |
| 6.07 | 0.05 | 255 | 15 | 5 | 12 | 4 | 12 | 1 | 1 | 1 | 4 | 231 | 151 | −1 | −2 | −227.248018 |
| 6.09 | 0.05 | 256 | 14 | 7 | 11 | 9 | 12 | −2 | −1 | 2 | −2 | 231 | 151 | 1 | 2 | −230.435028 |
| 6.12 | 0.04 | 257 | 16 | 2 | 9 | 5 | 11 | 1 | −1 | −3 | 0 | 231 | 151 | 2 | −2 | −233.654883 |
| 6.14 | 0.04 | 258 | 15 | 1 | 12 | 7 | 11 | 0 | 1 | −1 | 1 | 231 | 151 | −3 | 3 | −236.908011 |
| 6.16 | 0.04 | 259 | 15 | 2 | 13 | 7 | 11 | 1 | −2 | 6 | −4 | 231 | 151 | −1 | 0 | −240.194848 |
| 6.19 | 0.04 | 260 | 14 | 3 | 7 | 6 | 10 | −1 | 1 | 3 | 1 | 231 | 151 | 6 | −4 | −243.51584 |
| 6.21 | 0.04 | 261 | 15 | 2 | 4 | 10 | 10 | 0 | 0 | 0 | 7 | 231 | 151 | 3 | 1 | −246.871441 |
| 6.24 | 0.04 | 262 | 15 | 4 | 4 | 9 | 10 | 0 | 1 | −3 | −6 | 231 | 151 | 0 | 3 | −250.262113 |
| 6.26 | 0.04 | 263 | 15 | 3 | 7 | 2 | 9 | 0 | −1 | 3 | 3 | 231 | 150 | −3 | −5 | −253.688329 |
| 6.28 | 0.03 | 264 | 15 | 3 | 4 | 8 | 9 | 0 | −2 | 1 | 1 | 231 | 150 | 3 | 4 | −257.150569 |
| 6.31 | 0.03 | 265 | 15 | 2 | 3 | 5 | 8 | 0 | 0 | −6 | −3 | 231 | 150 | 1 | −2 | −260.649324 |
| 6.33 | 0.03 | 266 | 15 | 3 | 9 | 4 | 8 | 1 | 2 | 2 | 3 | 231 | 150 | −6 | 0 | −264.185093 |
| 6.35 | 0.03 | 267 | 14 | 5 | 7 | 7 | 8 | 0 | 2 | 1 | −1 | 231 | 150 | 2 | 1 | −267.758385 |
| 6.38 | 0.03 | 268 | 14 | 5 | 6 | 4 | 7 | 0 | −1 | −3 | −1 | 231 | 150 | 1 | −4 | −271.369718 |
| 6.40 | 0.03 | 269 | 14 | 3 | 9 | 5 | 7 | −1 | 2 | 1 | 0 | 231 | 150 | −3 | 1 | −275.01962 |
| 6.43 | 0.03 | 270 | 15 | 1 | 8 | 6 | 7 | −1 | −2 | 1 | 1 | 230 | 150 | 1 | 7 | −278.70863 |
| 6.45 | 0.03 | 271 | 16 | 2 | 7 | 6 | 6 | 1 | 1 | 2 | −1 | 230 | 150 | 1 | −6 | −282.437295 |
| 6.47 | 0.02 | 272 | 15 | 0 | 5 | 5 | 6 | 0 | 0 | −2 | 1 | 230 | 150 | 2 | 3 | −286.206171 |
| 6.50 | 0.02 | 273 | 15 | 2 | 7 | 6 | 6 | 0 | −1 | 1 | 1 | 230 | 150 | −2 | 1 | −290.015829 |
| 6.52 | 0.02 | 274 | 15 | 1 | 6 | 5 | 6 | 0 | 0 | −4 | 3 | 230 | 149 | 1 | −3 | −293.866844 |
| 6.55 | 0.02 | 275 | 15 | 1 | 10 | 4 | 5 | 0 | −2 | 1 | 0 | 230 | 149 | −4 | 3 | −297.759805 |
| 6.57 | 0.02 | 276 | 15 | 2 | 9 | 1 | 5 | 0 | 1 | 3 | −3 | 230 | 149 | 1 | −1 | −301.69531 |
| 6.59 | 0.02 | 277 | 15 | 2 | 6 | 1 | 5 | 1 | 0 | −3 | 4 | 230 | 149 | 3 | −1 | −305.67397 |
| 6.62 | 0.02 | 278 | 14 | 4 | 9 | 4 | 4 | 0 | 2 | 3 | 0 | 230 | 149 | −3 | 0 | −309.696403 |
| 6.64 | 0.02 | 279 | 14 | 3 | 6 | 0 | 4 | 0 | 0 | −2 | 0 | 230 | 149 | 3 | 1 | −313.763239 |
| 6.67 | 0.01 | 280 | 14 | 3 | 8 | 0 | 4 | −1 | −1 | 2 | −2 | 230 | 149 | −2 | −1 | −317.87512 |
| 6.69 | 0.01 | 281 | 15 | 1 | 6 | 0 | 3 | 0 | 0 | 2 | −1 | 230 | 149 | 2 | 1 | −322.032698 |
| 6.71 | 0.01 | 282 | 15 | 1 | 4 | 2 | 3 | 0 | 1 | −5 | −2 | 230 | 149 | 2 | 1 | −326.236636 |
| 6.74 | 0.01 | 283 | 15 | 2 | 9 | 3 | 3 | 0 | −1 | −2 | 1 | 230 | 149 | −5 | 3 | −330.487609 |
| 6.76 | 0.01 | 284 | 15 | 2 | 11 | 5 | 3 | 0 | 2 | 1 | 1 | 230 | 149 | −2 | 0 | −334.786301 |
| 6.78 | 0.01 | 285 | 15 | 1 | 10 | 4 | 2 | 0 | −1 | 2 | −6 | 230 | 148 | 1 | −3 | −339.13341 |
| 6.81 | 0.01 | 286 | 15 | 2 | 8 | 3 | 2 | 0 | 1 | 1 | 4 | 230 | 148 | 2 | 4 | −343.529645 |
| 6.83 | 0.01 | 287 | 15 | 0 | 7 | 9 | 2 | 0 | −2 | −5 | −2 | 230 | 148 | 1 | 0 | −347.975724 |
| 6.86 | 0.01 | 288 | 15 | 1 | 12 | 5 | 2 | 0 | −3 | −5 | 4 | 230 | 148 | −5 | 0 | −352.472381 |
| 6.88 | 0.01 | 289 | 15 | 0 | 17 | 7 | 1 | 1 | 2 | −1 | −4 | 230 | 148 | −5 | −2 | −357.020358 |
| 6.90 | 0.00 | 290 | 14 | 2 | 18 | 3 | 1 | −1 | 1 | 3 | −1 | 230 | 148 | −1 | −1 | −361.62041 |
| 6.93 | 0.00 | 291 | 15 | 5 | 15 | 7 | 1 | −1 | −1 | 4 | 5 | 230 | 148 | 3 | −2 | −366.273305 |
| 6.95 | 0.00 | 292 | 16 | 3 | 11 | 8 | 1 | −2 | 3 | 1 | −6 | 230 | 148 | 4 | 1 | −370.979823 |
| 6.98 | 0.00 | 293 | 18 | 2 | 10 | 3 | 1 | −2 | 0 | −5 | 9 | 230 | 148 | 1 | 1 | −375.740755 |
| 7.00 | 0.00 | 294 | 20 | 3 | 15 | 9 | 0 | 20 | 0 | 15 | 0 | 229 | 148 | −5 | −6 | −380.556906 |
| | | | | | | | | 0 | 0 | 0 | 0 | | | 15 | 4 | |
| | | | | | | | | 0 | 0 | 0 | 0 | | | 0 | −2 | |
| | | | | | | | | 0 | 0 | 0 | 0 | | | 0 | 4 | |
| | | | | | | | | 0 | 0 | 0 | 0 | | | 0 | −4 | |
| | | | | | | | | 0 | 0 | 0 | 0 | | | 0 | 1 | |
| | | | | | | | | 0 | 0 | 0 | 0 | | | 0 | 5 | |
| | | | | | | | | 0 | 0 | 0 | 0 | | | 0 | −6 | |
| | | | | | | | | 0 | 0 | 0 | 0 | | | 0 | 9 | |
| | | | | | | | | 0 | 0 | 0 | 0 | | | 0 | 0 | |
| | | | | | | | | 0 | 0 | 0 | 0 | | | 0 | 0 | |
| | | | | | | | | 0 | 0 | 0 | 0 | | | 0 | 0 | |
| | | | | | | | | 0 | 0 | 0 | 0 | | | 0 | 0 | |
| | | | | | | | | 0 | 0 | 0 | 0 | | | 0 | 0 | |
| | | | | | | | | 0 | 0 | 0 | 0 | | | 0 | 0 | |
| | | | | | | | | 0 | 0 | 0 | 0 | | | 0 | 0 | |
| | | | | | | | | 0 | 0 | 0 | 0 | | | 0 | 0 | |
| | | | | | | | | 0 | 0 | 0 | 0 | | | 0 | 0 | |
| | | | | | | | | 0 | 0 | 0 | 0 | | | 0 | 0 | |
| | | | | | | | | 0 | 0 | 0 | 0 | | | 0 | 0 | |
| | | | | | | | | 0 | 0 | 0 | 0 | | | 0 | 0 | |
| | | | | | | | | 0 | −4 | 0 | 0 | | | 0 | 0 | |
| | | | | | | | | 0 | 4 | 0 | −17 | | | 0 | 0 | |
| | | | | | | | | −24 | 0 | −21 | 17 | | | 0 | 0 | |
| | | MIN | 24 | 4 | 21 | 17 | | 24 | 0 | 21 | 0 | | | −21 | 0 | |
| | | | | | | | | | | | | | | 21 | 0 | |
| | | | | | | | | | | | | | | 0 | 0 | |
| | | | | | | | | | | | | | | 0 | 0 | |
| 0.02 | | | | | | | | | | | | | | 0 | 0 | |
| | | | | | | | | | | | | | | 0 | 0 | |
| | | | | | | | | | | | | | | 0 | 0 | |
| | | | | | | | | | | | | | | 0 | −17 | |
| | | | | | | | | | | | | | | 0 | 17 | |
| | | | | | | | | | | | | | | 0 | 0 | |

What is claimed is:

1. A system, comprising:
a mammography device for passing x-rays through a bone of a patient and recording signals corresponding to the x-rays passed through the bone; and
an analyzer for analyzing the signals recorded by the mammography device to determine a condition of the patient's bone.

2. The system of claim 1 wherein the mammography device includes a detector for recording the signals that is selected from the group consisting of screen-film detectors, computed radiography detectors, direct radiography detectors, indirect-conversion digital detectors and direct-conversion digital detectors.

3. The system of claim 1 wherein the analyzer comprises a computer-aided diagnosis (CAD) system with a workstation configured to reconstruct image data from the signals acquired by the detector.

4. The system of claim 3 wherein the CAD system comprises bone analysis software.

5. The system of claim 4 wherein the software is operable to generate a bone condition profile using a mammography image dataset.

6. The system of claim 5 wherein the software is operable to construct the bone condition profile using a lookup table (LUT).

7. The system of claim 6 wherein the LUT is generated comprising normalized data structure obtained using a calibration tool.

8. The system of claim 7 wherein the calibration tool includes an aluminum alloy wedge having a thickness of about 0.5-7 mm.

9. A method of analyzing a bone condition comprising:
passing X-rays from a mammography device through a bone of a patient;
recording the X-rays passed through the bone as signals in a detector of the mammography device; and
analyzing the signals to determine a bone condition.

10. The method of claim 9, wherein determining the bone condition includes generating a bone condition profile.

11. The method of claim 10 wherein generating the bone condition profile includes use of a lookup table (LUT).

12. The method of claim 11 wherein the lookup table (LUT) includes a normalized data structure from a standard x-ray image dataset.

13. The method of claim 11 wherein the lookup table (LUT) is constructed from a mammography profile and a conventional profile.

14. The method of claim 13 wherein the mammography profile and conventional profiles are generated including use of a calibration tool.

15. The method of claim 14 wherein the calibration tool is an aluminum alloy wedge.

16. A tangible, machine readable media comprising:
code adapted to acquire a plurality of bone x-ray image data or datasets from a mammography device; and code adapted to translate the image data to form a bone condition profile.

17. The tangible, machine readable media of claim 16 wherein the code adapted to translate the image data to form a bone condition profile includes use of a bone mineral density measurement software.

18. The tangible, machine readable media of claim 16 wherein the plurality of bone x-ray image data or datasets are generated including use of a calibration tool.

19. The tangible, machine readable media of claim 18 wherein the calibration tool is an aluminum alloy wedge.

20. The tangible, machine readable media of claim 19 which is stored and/or executed in a computer processor.
